(19) United States
(12) Patent Application Publication
(10) Pub. No.: US 2026/0113684 A1
(43) Pub. Date: Apr. 23, 2026

(54) REPORTING ENFORCED URSP RULES

(71) Applicant: QUALCOMM Incorporated, San Diego, CA (US)

(72) Inventors: Sunghoon KIM, San Diego, CA (US); Lenaig Genevieve CHAPONNIERE, La Jolla, CA (US); Hong CHENG, Basking Ridge, NJ (US); Haris ZISIMOPOULOS, London (GB)

(21) Appl. No.: 19/117,914

(22) PCT Filed: Nov. 6, 2023
(86) PCT No.: PCT/US2023/078851

§ 371 Date: Apr. 2, 2025

(30) Foreign Application Priority Data
Nov. 7, 2022 (GR) 20220100908

(51) Int. Cl. H04W 40/02; H04L 41/0894

(52) U.S. Cl. CPC H04W 40/02; H04L 41/0894

(57) ABSTRACT

Apparatus, methods, and computer program products for wireless communication are provided. An example method may include receiving, from a second network entity, a set of RSP rules. The example method may further include receiving, from the second network entity, information indicative of enforced RSP rule information, where the enforced RSP rule information is associated with at least one rule of the set of RSP rules. The example method may further include transmitting, to a third network entity, the enforced RSP rule information.

### CROSS REFERENCES

The present Application is a 371 national stage filing of International PCT Application No. PCT/US2023/078851 by KIM et al., entitled “REPORTING ENFORCED URSP RULES,” filed Nov. 6, 2023; and claims priority to Greek patent application No. 20220100908 by KIM et al. entitled “REPORTING ENFORCED URSP RULES,” filed Nov. 7, 2022, each of which is assigned to the assignee hereof, and each of which is expressly incorporated by reference in its entirety herein.

### TECHNICAL FIELD

The present disclosure relates generally to communication systems, and more particularly, to wireless communication systems with route selection policy (RSP) rules.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network entity, such as a user equipment (UE), are provided. The apparatus may include a memory and at least one processor coupled to the memory. The at least one processor may be configured to receive, from a second network entity, a set of route selection policy (RSP) rules. The at least one processor may be configured to receive, from the second network entity, information indicative of or associated with enforced RSP rule information, where the enforced RSP rule information is associated with or pertains to enforcement, by the first network entity, of at least one rule of the set of RSP rules. The at least one processor may be configured to transmit, to a third network entity, the enforced RSP rule information based on receiving the information associated with the enforced RSP rule information.

In another aspect of the disclosure, a method, a computer-readable medium, and an apparatus at a first network entity, such as a network node, are provided. The apparatus may include a memory and at least one processor coupled to the memory. The at least one processor may be configured to transmit, for a second network entity, a set of RSP rules. The at least one processor may be configured to transmit, for the second network entity, information indicative of or associated with enforced RSP rule information, where the enforced RSP rule information is associated with or pertains to enforcement, by the second network entity, of at least one rule of the set of RSP rules. The at least one processor may be configured to receive the enforced RSP rule information.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example communications between network entities and a UE.

FIG. 5 is a flowchart of a method of wireless communication.

FIG. 6 is a flowchart of a method of wireless communication.

FIG. 7 is a flowchart of a method of wireless communication.

FIG. 8 is a diagram illustrating an example of a hardware implementation for an example apparatus and/or network entity.

FIG. 9 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

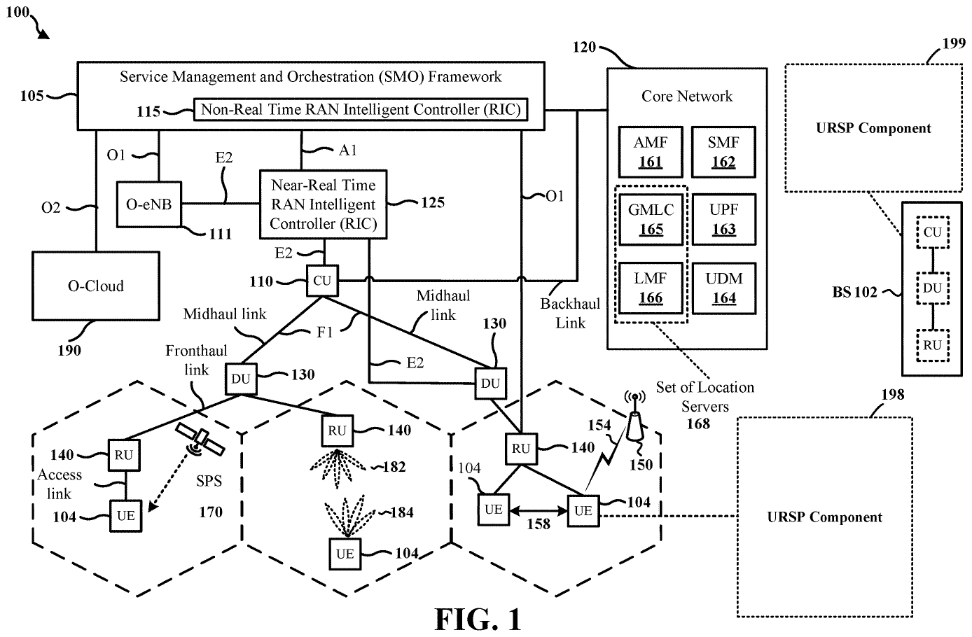

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a URSP component 198. In some aspects, the URSP component 198 may be configured to receive, from a second network entity, a set of RSP rules. In some aspects, the URSP component 198 may be configured to receive, from the second network entity, information indicative of enforced RSP rule information, where the enforced RSP rule information is associated with at least one rule of the set of RSP rules. In some aspects, the URSP component 198 may be configured to transmit, to a third network entity, the enforced RSP rule information.

In certain aspects, the base station 102 may include a URSP component 199. In some aspects, the URSP component 199 may be configured to transmit, for a second network entity, a set of RSP rules. In some aspects, the URSP component 199 may be configured to transmit, for the second network entity, information indicative of enforced RSP rule information, where the enforced RSP rule information is associated with at least one rule of the set of RSP rules. In some aspects, the URSP component 199 may be configured to receive the enforced RSP rule information.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a SMF, and the third network node may be a PCF. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

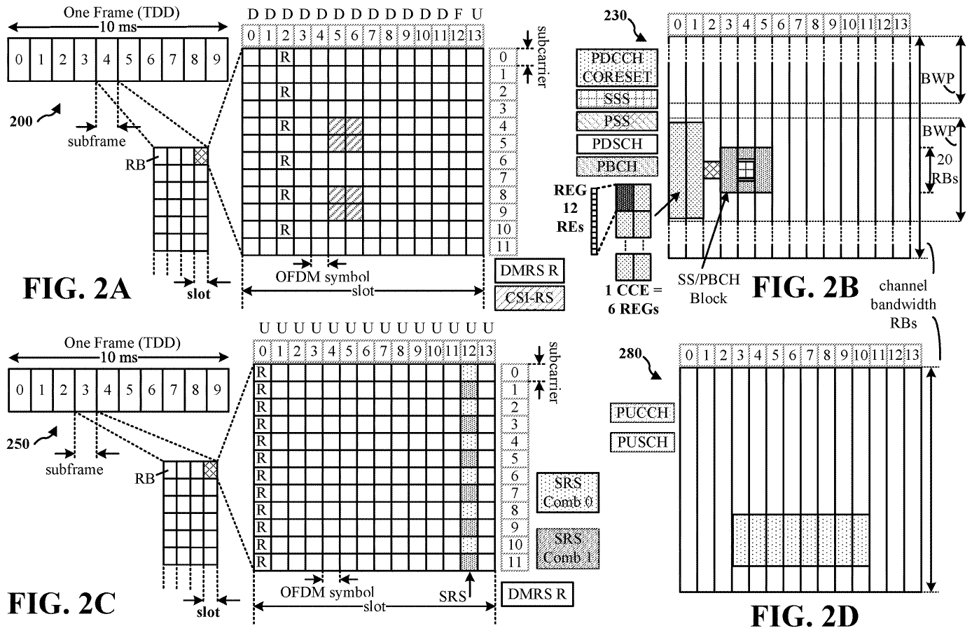

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

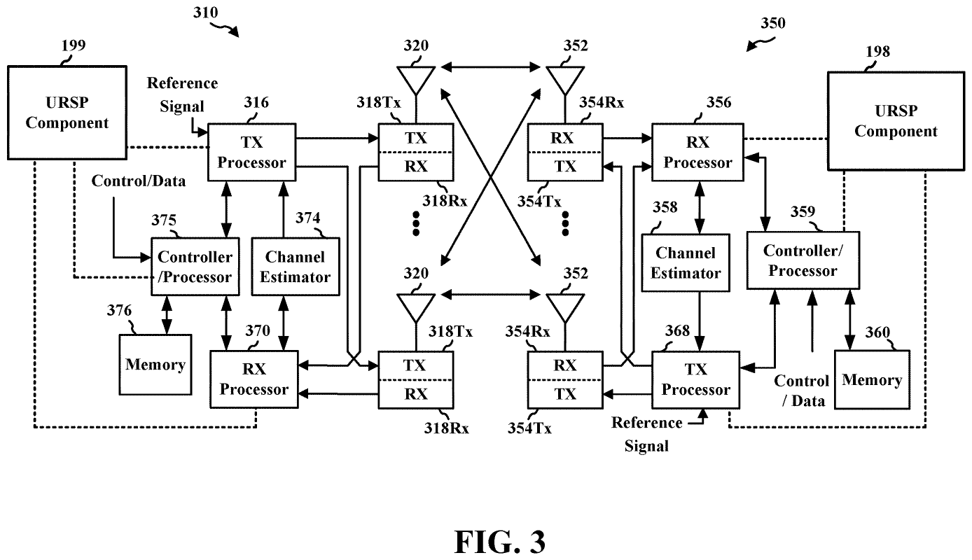

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with URSP component 198 of FIG. 1.

At least one of the TX processor 316, the RX processor 370, and the controller/processor 375 may be configured to perform aspects in connection with URSP component 199 of FIG. 1.

As used here, the term “RSP rules” may refer to UE RSP (URSP) rules or other types of RSP rules. A URSP rule may be related to applications and associated PDU sessions for a UE. A URSP may include information mapping user data traffic for applications to PDU session connectivity parameters. The user data traffic may be defined in the URSP rule by a “traffic descriptor” parameter that may include IP filter parameters, medium access control (MAC) address parameters such as MAC address type, MAC address range type, or the like, or an identifier (ID) associated with the application in which the user data traffic belongs to. The URSP rule may be used by an UE to determine whether the UE may use an already established PDU session or trigger establishment of a new PDU session upon starting of the application associated with the URSP rule. The URSP rule may be used for enforcing how data traffic related to applications may be routed.

An example URSP rule may include a list of route selection descriptors which may include route selection components, session and service continuity (SCC) mode selection, network slice selection (e.g., one or more values of single network slice selection assistance information), data network name (DNN) selection (e.g., one or more values of DNNs), access type (e.g., 3GPP, non-3GPP, or multi-access), PDU session type selection (one or more values of PDU session type), indication regarding if the traffic of the matching application is to be offloaded to non-3GPP access outside of a PDU Session, indication regarding if the traffic of the matching application may be sent via a Layer-3 UE-to-Network Relay outside of a PDU session, time window in which matching traffic is allowed, or other parameters. An example URSP rule may include a rule precedence that may determine the order in which the URSP may be enforced at the UE. An example URSP rule may also include the traffic descriptor associated with the URSP rule.

User data may flow from a source to a final destination. The user data may be included in quality of service (QoS) flows with different levels of priority, data rate, latency specification, or the like. A QoS flow may be a finest granularity of QoS differentiation in a PDU session. A QoS flow ID may be used for identifying each QoS flow in the PDU session. Different QoS flows in a PDU session may belong to different applications. Information regarding whether a URSP rule is enforced (which may be otherwise referred to as “applied”) at a UE may enable the network to determine a policy and charging control (PCC) rule associated with a QoS flow so that an SMF in the network may be configured accordingly. For example, a QoS flow with a higher priority or lower latency may be determined to be associated with a different PCC rule compared with a QoS flow with a lower priority or higher latency. As used herein, the term “PCC rule” may refer to QoS rule for the traffic and charging information for a service data flow (which may be the data traffic) PCC rule may facilitate automated charging by a network operator for data traffic related to a UE.

Because the URSP rules may affect how a QoS flow is handled and how much resources a QoS flow may occupy (e.g., whether a new PDU session is triggered), information regarding which URSP rules are enforced may facilitate the network to determine the PCC rule associated with a QoS flow. Aspects provided herein may enable a network to obtain information regarding which RSP rule is enforced at a UE to facilitate determination of PCC rule. Aspects provided herein may save backend signaling in the wireless communication network. The network may obtain information regarding which URSP rules are enforced at a UE to determine how the QoS flows related to applications at the UE are handled, enabling determining PCC rules with less backend signaling to check with application servers regarding the QoS flows related to the applications. Without aspects provided herein, the network may rely more on backend signaling with application servers to obtain information regarding the QoS flows related to the applications. Without aspects provided herein, the network may not be able to determine PCC rule by itself without signaling with the application servers. By enabling the wireless communication network to obtain information regarding which URSP rules are enforced at a UE, a lot of backend signaling with applications servers may be eliminated.

As used herein, the term “enforced RSP rule information” may refer to information reported from a UE to the network indicative of enforcement of at least one rule associated with the enforced RSP rule information. For example, the at least one rule may be associated with the enforced RSP rule information based on the enforced RSP rule information including a rule ID that identifies the at least one rule. By transmitting the rule ID in the enforced RSP rule information, the UE is informing the network that the URSP rule identified by the rule ID would be enforced. As used herein, the term “information indicative of enforced RSP rule information” may refer to information transmitted from the network to the UE that identify one or more rules that the network would like the UE to enforce. For example, a network may include one or more URSP rule IDs in a traffic descriptor to inform a UE that the URSP rules associated with the URSP rule ID may be enforced.

Enforced RSP rule information may be included in a PDU session establishment request, a PDU session modification request, or a service request associated with a PDU session. As used herein, the term “PDU session establishment request” may refer to a request for establishing a PDU session transmitted from a UE to the network. As used herein, the term “PDU session modification request” may refer to a request for creating a dedicated QoS flow by modifying a PDU session for a UE or to inform any change for the PDU session. A PDU session modification request may be transmitted from the UE to the network. As used herein, the term “service request” may refer to a request transmitted from the UE in an idle state to the network for reactivating a PDU session.

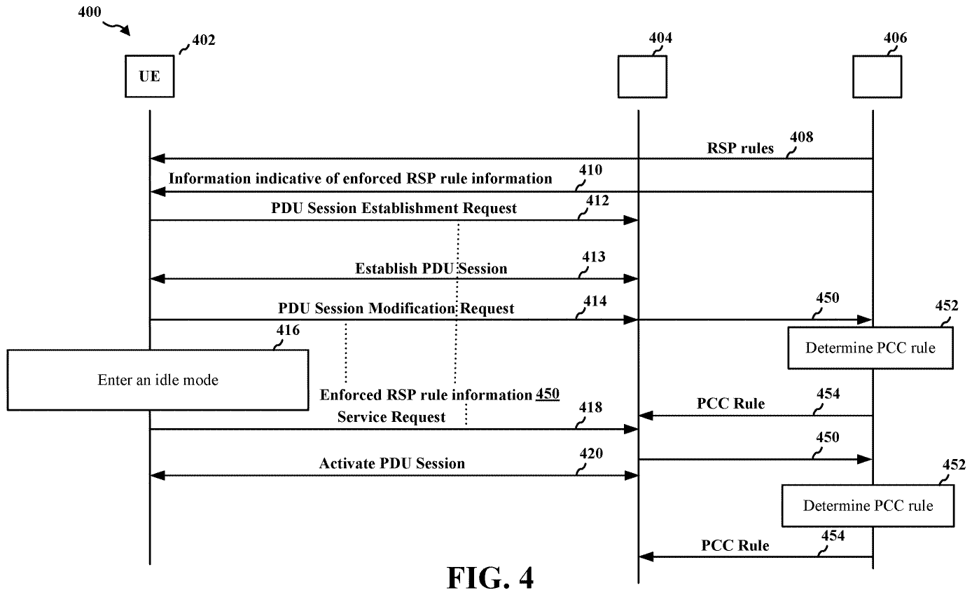

FIG. 4 is a diagram 400 illustrating example communications between network entities (a first network entity 404 and a second network entity 406) and a UE 402. In some aspects, the network entity 404/406 may be implemented in connection with a network node that may support a RAN. In some aspects, the network node may be implemented as an aggregated base station, a disaggregated base station, an integrated access and backhaul (IAB) node, a relay node, a sidelink node, or the like. In some aspects, the network node may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some aspects, the network entity 404 may include or may be an SMF. In some aspects, the network entity 406 may include or may be a policy control function (PCF).

As illustrated in FIG. 4, the network entity 406 may transmit a set of RSP rules 408 to the UE 402. The set of RSP rules 408 may include a set of URSP rules. The URSP rule may be used by the UE 402 to determine whether the UE 402 may use an already established PDU session or trigger establishment of a new PDU session upon starting of an application associated with a URSP rule. The URSP rule may be used for enforcing how data traffic related to applications may be routed. An example URSP rule may include a list of route selection descriptors which may include route selection components, SCC mode selection, network slice selection (e.g., one or more values of single network slice selection assistance information), DNN selection (e.g., one or more values of DNNs), access type (e.g., 3GPP, non-3GPP, or multi-access), PDU session type selection (one or more values of PDU session type), indication regarding if the traffic of the matching application is to be offloaded to non-3GPP access outside of a PDU Session, indication regarding if the traffic of the matching application may be sent via a Layer-3 UE-to-Network Relay outside of a PDU session, time window in which matching traffic is allowed, or other parameters. An example URSP rule may include a rule precedence that may determine the order in which the URSP may be enforced at the UE. An example URSP rule may also include the traffic descriptor associated with the URSP rule. In some aspects, each URSP rule may be associated with a URSP rule ID. In some aspects, the URSP rule ID may be included in an information element (IE) that carries the URSP rule. In some aspects, a URSP rule ID may be included in a traffic descriptor associated with the URSP rule. In some aspects, a URSP rule ID may be included as a traffic descriptor of a certain type dedicated for URSP rule ID.

In some aspects, the network entity 406 may transmit information indicative of the enforced RSP rule information 410 to the UE 402 to indicate requested reporting of enforcement of at least one rule of the set of RSP rules (e.g., instruct/request reporting of whether the UE 402 actually enforced the at least one rule in enforced RSP rule information 450). In some aspects, the information indicative of the enforced RSP rule information 410 may be transmitted with the set of RSP rules 408. For example, the information indicative of the enforced RSP rule information 410 may be included in respective traffic descriptors associated with the at least one rule (instructed/requested to be enforced). From the network entity 406 (or a PCF)'s point of view, providing a URSP rule ID in the traffic descriptor may instruct or request the UE 402 to report whether an evaluation result of the traffic descriptor and whether the URSP rule identified by the URSP rule ID would be enforced. From the UE 402's point of view, based on the presence of the URSP rule ID in the traffic descriptor, the UE 402 may report whether the URSP rule identified by the URSP rule ID would be enforced (e.g., if it is matched during the URSP evaluation).

In some aspects, the UE may transmit a PDU session establishment request 412 to the network entity 404. In some aspects, the PDU session establishment request 412 may include the enforced RSP rule information 450. The network entity 404 may establish the PDU session accordingly with the UE 402 (which may involve signaling with other network entities) at 413. In some aspects, the enforced RSP rule information 450 may indicate which RSP rules are enforced at the UE 402. In some aspects, the enforced RSP rule information 450 may include one or more URSP rule IDs associated with the RSP rules enforced at the UE 402.

In some aspects, in creating a dedicated QoS flow for an application at the UE 402, the UE 402 may also transmit a PDU session modification request 414. In some aspects, the PDU session modification request 414 may include the enforced RSP rule information 450. In some aspects, the enforced RSP rule information 450 may indicate which RSP rules are enforced at the UE 402. In some aspects, the enforced RSP rule information 450 may include a PDU session ID associated with the PDU session modification request 414 and one or more URSP rule IDs associated with the RSP rules enforced at the UE 402. In some aspects, the PDU session modification request 414 may not be dedicated for the enforced RSP rule information 450 even though the PDU session modification request 414 may include the enforced RSP rule information 450. For example, the PDU session modification request 414 may include other information.

In some aspects, if there is no activity on the application layer associated with the UE 402, the PDU session may become inactive and the UE 402 may enter an idle mode at 416. When an application at the UE 402 requests connectivity, the UE 402 may perform a service request procedure by transmitting a service request 418 to the network entity 404. In some aspects, the service request 418 may include the PDU session ID to be re-activated. In some aspects, the service request 418 may include the enforced RSP rule information 450. In some aspects, the enforced RSP rule information 450 may indicate which RSP rules are enforced at the UE 402. In some aspects, the enforced RSP rule information 450 may include the PDU session ID associated with the service request 418 and one or more URSP rule IDs associated with the RSP rules enforced at the UE 402. Based on receiving the service request 418, the network entity 404 may reactivate the PDU session with the UE at 420. As an example, the service request 418 may include a service request message identity, a S-temporary mobile subscriber identity (S-TMSI) associated with the UE 402, an uplink data status IE indicative of the PDU session(s) for which the UE 402 has pending user data to be sent, a PDU session status, an allowed PDU session status, a non-access-stratum (NAS) message container, a UE request type IE, a paging restriction, or the enforced RSP rule information 450. In some aspects, the enforced RSP rule information 450 may be included with an uplink data status IE. In some aspects, the enforced RSP rule information 450 be an IE which may include one or more rule IDs associated with the enforced URSP rules. In some aspects, IE may also include an enforced URSP rule report IE identifier (IEI) indicative of that the IE is enforced RSP rule information 450. In some aspects, the IE may include a IE indicative of the length of the enforced RSP rule information 450. In some aspects, in one or more IEs respectively including the one or more rule IDs associated with the enforced URSP rules, PDU session ID (which may also be included in uplink data status IE) and rule IDs associated with the PDU session that may not be enforced may also be included. In some aspects, in the one or more IEs respectively including the one or more rule IDs associated with the enforced URSP rules, an IE indicative of a length of the respective IE including the rule ID may be included.

From the network entity 404 (or a PCF)'s point of view, after a URSP rule ID is reported by the UE 402 (e.g., in the enforced RSP rule information 450), the network entity may determine that the URSP rule identified by the URSP rule ID is enforced at the UE 402.

In some aspects, upon receiving the enforced RSP rule information 450 in the PDU session establishment request 412, the PDU session modification request 414, or the service request 418, the network entity 404 may transmit the enforced RSP rule information 450 to another network entity (e.g., network entity 406), which may be a PCF. The network entity 406, which may be a PCF, may determine, at 452, a PCC rule 454 associated with a QoS flow that the PDU session establishment request 412, the PDU session modification request 414, or the service request 418 (e.g., triggered based on the QoS flow) carrying or associated with the enforced RSP rule information 450 supports. The network entity 406 may transmit the PCC rule 454 back to an SMF, which may be the network entity 404.

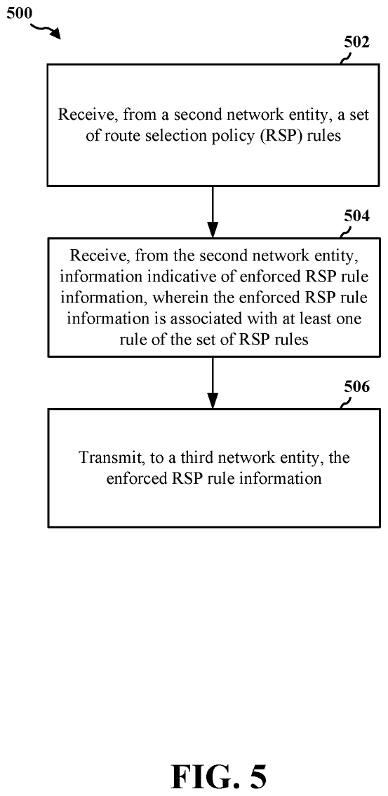

FIG. 5 is a flowchart 500 of a method of wireless communication. The method may be performed by a first network entity, such as a UE (e.g., the UE 104, the UE 402; the apparatus 804).

At 502, the first network entity may receive, from a second network entity, a set of RSP rules. For example, the UE 402 may receive, from a second network entity (e.g., network entity 406), a set of RSP rules (e.g., 408). In some aspects, 502 may be performed by URSP component 198.

At 504, the first network entity may receive, from the second network entity, information indicative of enforced RSP rule information, where the enforced RSP rule information is associated with at least one rule of the set of RSP rules. For example, the UE 402 may receive, from the second network entity (e.g., network entity 406), information indicative of enforced RSP rule information (e.g., 410), where the enforced RSP rule information is associated with at least one rule of the set of RSP rules. In some aspects, 504 may be performed by URSP component 198. In some aspects, the information indicative of the enforced RSP rule information is a traffic descriptor. In some aspects, the traffic descriptor includes at least one ID respectively associated with the at least one rule of the set of RSP rules. In some aspects, the enforced RSP rule information is associated with a policy and charging control (PCC) rule.

At 506, the first network entity may transmit, to a third network entity, the enforced RSP rule information. For example, the UE 402 may transmit, to a third network entity (e.g., network entity 404), the enforced RSP rule information 450 (e.g., in one or more of 412, 414, or 418). In some aspects, 506 may be performed by URSP component 198. In some aspects, to transmit the enforced RSP rule information, the first network entity may transmit the enforced RSP rule information in a PDU session establishment request. In some aspects, the PDU session establishment request may include the enforced RSP rule information and other information. In some aspects, to transmit the enforced RSP rule information, the first network entity may transmit the enforced RSP rule information in a PDU session modification request. In some aspects, the PDU session modification request may include the enforced RSP rule information and other information. In some aspects, to transmit the enforced RSP rule information, the first network entity may transmit the enforced RSP rule information in a service request associated with at least one PDU session. In some aspects, the service request may be transmitted for reactivating the at least one PDU session after the first network entity enters an idle mode. In some aspects, the service request may include the enforced RSP rule information and other information. In some aspects, to transmit the enforced RSP rule information, the first network entity may transmit the enforced RSP rule information with an uplink data status information element (IE) indicative of whether each PDU session of the at least one PDU session is associated with pending user data to be transmitted.

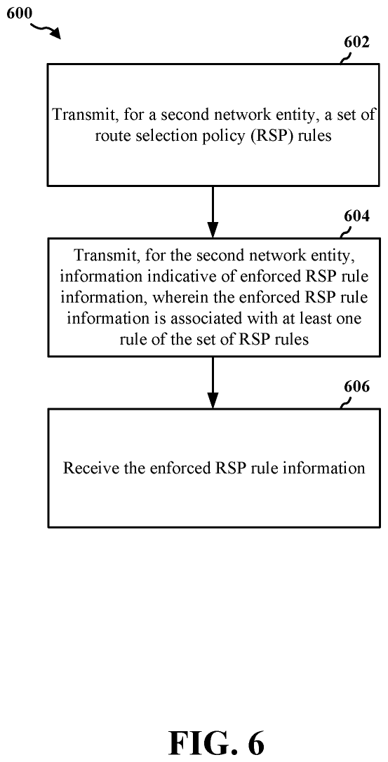

FIG. 6 is a flowchart 600 of a method of wireless communication. The method may be performed by a network entity (e.g., the base station 102, the network entity 406, the network entity 802, the network entity 902).

At 602, the first network entity may transmit, for a second network entity, a set of RSP rules. For example, the network entity 406 may transmit, for a second network entity (e.g., the UE 402), a set of RSP rules (e.g., 408). In some aspects, 602 may be performed by URSP component 199.

At 604, the first network entity may transmit, for the second network entity, information indicative of enforced RSP rule information, where the enforced RSP rule information is associated with at least one rule of the set of RSP rules. For example, the network entity 406 may transmit, for the second network entity (e.g., the UE 402), information indicative of enforced RSP rule information (e.g., 410) through the RAN, where the enforced RSP rule information is associated with at least one rule of the set of RSP rules. In some aspects, 604 may be performed by URSP component 199. In some aspects, the information indicative of the enforced RSP rule information is a traffic descriptor. In some aspects, the traffic descriptor includes at least one ID respectively associated with the at least one rule of the set of RSP rules.

At 606, the first network entity may receive the enforced RSP rule information. For example, the network entity 406 may receive the enforced RSP rule information 450 (e.g., transmitted to the network entity 404 in 412, 414, or 418 and the network entity 404 may transmit the enforced RSP rule information 450 to the network entity 406). In some aspects, 606 may be performed by URSP component 199.

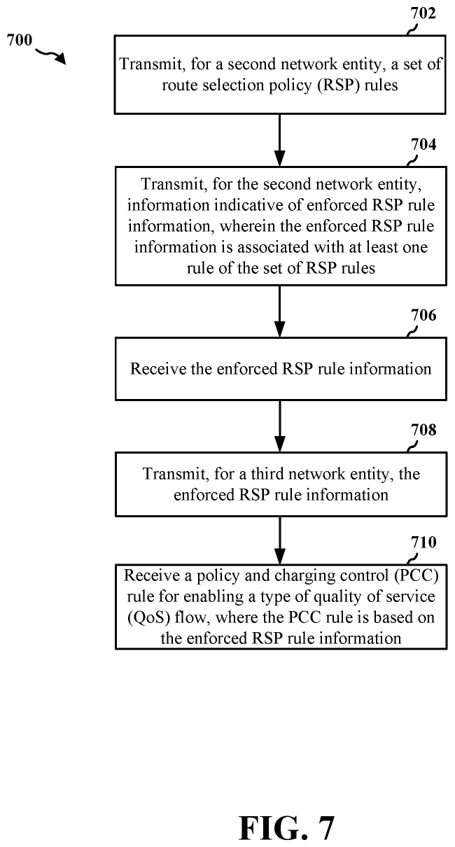

FIG. 7 is a flowchart 700 of a method of wireless communication. The method may be performed by a network entity (e.g., the base station 102, a radio access network associated with (e.g., supporting) the network entity 404 and the network entity 406, the network entity 802, the network entity 902).

At 702, the first network entity may transmit, for a second network entity, a set of RSP rules. For example, a RAN supporting the network entity 406 may transmit, for a second network entity (e.g., the UE 402), a set of RSP rules (e.g., 408). In some aspects, 702 may be performed by URSP component 199.

At 704, the first network entity may transmit, for the second network entity, information indicative of enforced RSP rule information, where the enforced RSP rule information is associated with at least one rule of the set of RSP rules. For example, the RAN supporting the network entity 406 may transmit, for the second network entity (e.g., the UE 402), information indicative of enforced RSP rule information (e.g., 410), where the enforced RSP rule information is associated with at least one rule of the set of RSP rules. In some aspects, 704 may be performed by URSP component 199. In some aspects, the information indicative of the enforced RSP rule information is a traffic descriptor. In some aspects, the traffic descriptor includes at least one ID respectively associated with the at least one rule of the set of RSP rules. In some aspects, the information indicative of the enforced RSP rule information is a traffic descriptor. In some aspects, the traffic descriptor includes at least one ID respectively associated with the at least one rule of the set of RSP rules.

At 706, the first network entity may receive the enforced RSP rule information. For example, the RAN supporting the network entity 404 may receive the enforced RSP rule information 450 (e.g., in 412, 414, or 418). In some aspects, 706 may be performed by URSP component 199.

In some aspects, to receive the enforced RSP rule information, the first network entity may receive the enforced RSP rule information in a PDU session establishment request. In some aspects, the PDU session establishment request may include the enforced RSP rule information and other information. In some aspects, to receive the enforced RSP rule information, the first network entity may receive the enforced RSP rule information in a PDU session modification request. In some aspects, the PDU session modification request may include the enforced RSP rule information and other information. In some aspects, to receive the enforced RSP rule information, the first network entity may receive the enforced RSP rule information in a service request associated with at least one PDU session. In some aspects, the service request may be received for reactivating the at least one PDU session after or when the first network entity enters or is in an idle mode or the first network entity has not activated yet the PDU session. In some aspects, the service request may include the enforced RSP rule information and other information. In some aspects, to receive the enforced RSP rule information, the first network entity may receive the enforced RSP rule information with an uplink data status IE indicative of whether each PDU session of the at least one PDU session is associated with pending user data to be transmitted.

At 708, the first network entity may transmit, for a third network entity, the enforced RSP rule information. For example, the RAN supporting the network entity 404 may transmit, for a third network entity (e.g., 406), the enforced RSP rule information (e.g., 450). In some aspects, 708 may be performed by URSP component 199. The third network entity may determine a PCC rule based on the enforced RSP rule information (e.g., at 452).

At 710, the first network entity may receive a PCC rule to enable a type of QoS flow, where the PCC rule is based on the enforced RSP rule information. For example, the network entity 404 may receive (e.g., from the network entity 406) a PCC rule (e.g., 454) to enable a type of QoS flow, where the PCC rule is based on the enforced RSP rule information. In some aspects, 710 may be performed by URSP component 199.

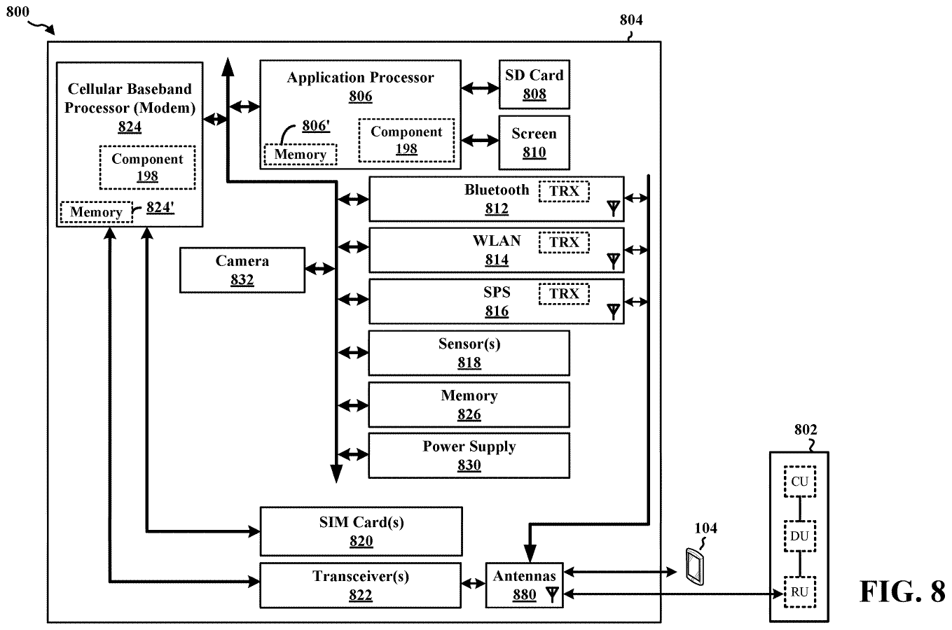

FIG. 8 is a diagram 800 illustrating an example of a hardware implementation for an apparatus 804. The apparatus 804 may be a UE, a component of a UE, or may implement UE functionality. In some aspects, the apparatus 804 may include a cellular baseband processor 824 (also referred to as a modem) coupled to one or more transceivers 822 (e.g., cellular RF transceiver). The cellular baseband processor 824 may include on-chip memory 824′. In some aspects, the apparatus 804 may further include one or more subscriber identity modules (SIM) cards 820 and an application processor 806 coupled to a secure digital (SD) card 808 and a screen 810. The application processor 806 may include on-chip memory 806′. In some aspects, the apparatus 804 may further include a Bluetooth module 812, a WLAN module 814, a satellite system module 816 (e.g., GNSS module), one or more sensor modules 818 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 826, a power supply 830, and/or a camera 832. The Bluetooth module 812, the WLAN module 814, and the satellite system module 816 may include an on-chip transceiver (TRX)/receiver (RX). The cellular baseband processor 824 communicates through the transceiver(s) 822 via one or more antennas 880 with the UE 104 and/or with an RU associated with a network entity 802. The cellular baseband processor 824 and the application processor 806 may each include a computer-readable medium/memory 824′, 806′, respectively. The additional memory modules 826 may also be considered a computer-readable medium/memory. Each computer-readable medium/memory 824′, 806′, 826 may be non-transitory. The cellular baseband processor 824 and the application processor 806 are each responsible for general processing, including the execution of software stored on the computer-readable medium/memory. The software, when executed by the cellular baseband processor 824/application processor 806, causes the cellular baseband processor 824/application processor 806 to perform the various functions described herein. The computer-readable medium/memory may also be used for storing data that is manipulated by the cellular baseband processor 824/application processor 806 when executing software. The cellular baseband processor 824/application processor 806 may be a component of the UE 350 and may include the memory 360 and/or at least one of the TX processor 368, the RX processor 356, and the controller/processor 359. In one configuration, the apparatus 804 may be a processor chip (modem and/or application) and include just the cellular baseband processor 824 and/or the application processor 806, and in another configuration, the apparatus 804 may be the entire UE (e.g., see 350 of FIG. 3) and include the additional modules of the apparatus 804.

As discussed herein, the URSP component 198 may be configured to receive, from a second network entity, a set of RSP rules. In some aspects, the URSP component 198 may be configured to receive, from the second network entity, information indicative of enforced RSP rule information, where the enforced RSP rule information is associated with at least one rule of the set of RSP rules. In some aspects, the URSP component 198 may be configured to transmit, to a third network entity, the enforced RSP rule information. The URSP component 198 may be within the cellular baseband processor 824, the application processor 806, or both the cellular baseband processor 824 and the application processor 806. The URSP component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 804 may include a variety of components configured for various functions. In one configuration, the apparatus 804, and in particular the cellular baseband processor 824 and/or the application processor 806, includes means for receiving, from a second network entity, a set of RSP rules. In some aspects, the apparatus 804 may further include means for receiving, from the second network entity, information indicative of enforced RSP rule information, where the enforced RSP rule information is associated with at least one rule of the set of RSP rules. In some aspects, the apparatus 804 may further include means for transmitting, to a third network entity, the enforced RSP rule information. The means may be the URSP component 198 of the apparatus 804 configured to perform the functions recited by the means. As described herein, the apparatus 804 may include the TX processor 368, the RX processor 356, and the controller/processor 359. As such, in one configuration, the means may be the TX processor 368, the RX processor 356, and/or the controller/processor 359 configured to perform the functions recited by the means.

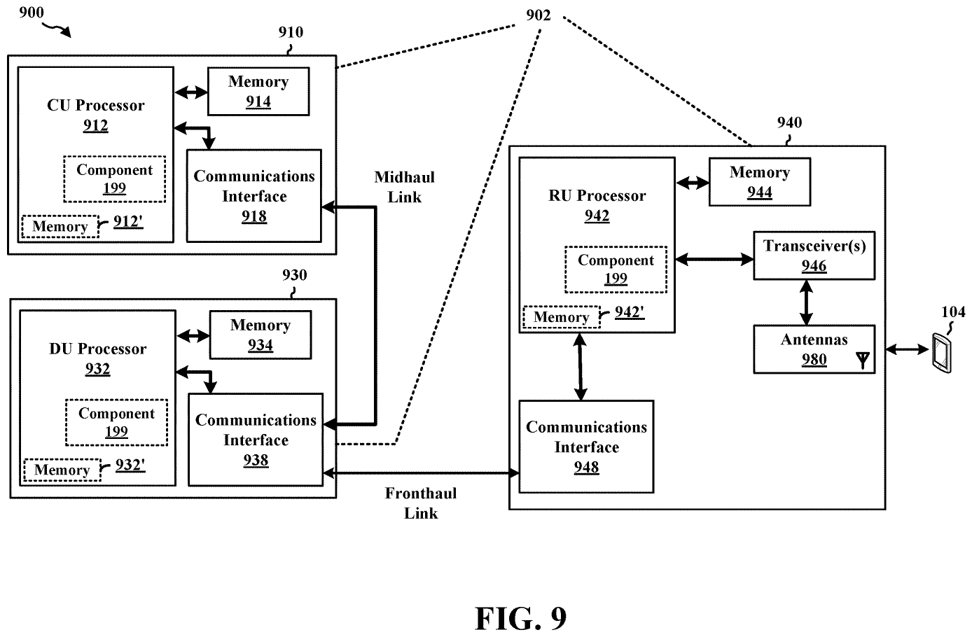

FIG. 9 is a diagram 900 illustrating an example of a hardware implementation for a network entity 902. The network entity 902 may be a BS, a component of a BS, or may implement BS functionality. The network entity 902 may include at least one of a CU 910, a DU 930, or an RU 940. For example, depending on the layer functionality handled by the component 199, the network entity 902 may include the CU 910; both the CU 910 and the DU 930; each of the CU 910, the DU 930, and the RU 940; the DU 930; both the DU 930 and the RU 940; or the RU 940. The CU 910 may include a CU processor 912. The CU processor 912 may include on-chip memory 912′. In some aspects, the CU 910 may further include additional memory modules 914 and a communications interface 918. The CU 910 communicates with the DU 930 through a midhaul link, such as an F1 interface. The DU 930 may include a DU processor 932. The DU processor 932 may include on-chip memory 932′. In some aspects, the DU 930 may further include additional memory modules 934 and a communications interface 938. The DU 930 communicates with the RU 940 through a fronthaul link. The RU 940 may include an RU processor 942. The RU processor 942 may include on-chip memory 942′. In some aspects, the RU 940 may further include additional memory modules 944, one or more transceivers 946, antennas 980, and a communications interface 948. The RU 940 communicates with the UE 104. The on-chip memory 912′, 932′, 942′ and the additional memory modules 914, 934, 944 may each be considered a computer-readable medium/memory. Each computer-readable medium/memory may be non-transitory. Each of the processors 912, 932, 942 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the URSP component 199 may be configured to transmit, for a second network entity, a set of RSP rules. In some aspects, the URSP component 199 may be configured to transmit, for the second network entity, information indicative of enforced RSP rule information, where the enforced RSP rule information is associated with at least one rule of the set of RSP rules. In some aspects, the URSP component 199 may be configured to receive the enforced RSP rule information. The URSP component 199 may be within one or more processors of one or more of the CU 910, DU 930, and the RU 940. The URSP component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 902 may include a variety of components configured for various functions. In one configuration, the network entity 902 includes means for transmitting, for a second network entity, a set of RSP rules. In some aspects, the network entity 902 may further include means for transmitting, for the second network entity, information indicative of enforced RSP rule information, where the enforced RSP rule information is associated with at least one rule of the set of RSP rules. In some aspects, the network entity 902 may further include means for receiving the enforced RSP rule information. In some aspects, the network entity 902 may further include means for receiving a policy and charging control (PCC) rule for enabling a type of quality of service (QoS) flow, wherein the PCC rule is based on the enforced RSP rule information. In some aspects, the network entity 902 may further include means for receiving a policy and charging control (PCC) rule for enabling a type of quality of service (QoS) flow, where the PCC rule is based on the enforced RSP rule information. The means may be the URSP component 199 of the network entity 902 configured to perform the functions recited by the means. As described herein, the network entity 902 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1: A first network entity for wireless communication, comprising: a memory; and at least one processor coupled to the memory, wherein the at least one processor is configured to: receive, from a second network entity, a set of route selection policy (RSP) rules; receive, from the second network entity, information associated with enforced RSP rule information, wherein the enforced RSP rule information pertains to enforcement, by the first network entity, of at least one rule of the set of RSP rules; and transmit, to a third network entity, the enforced RSP rule information based on receiving the information associated with the enforced RSP rule information.

Aspect 2: The first network entity of aspect, wherein to transmit the enforced RSP rule information, the at least one processor is configured to transmit the enforced RSP rule information in a service request associated with at least one protocol data unit (PDU) session.

Aspect 3: The first network entity of aspect, further comprising: determining, while the first network entity is in an idle state, whether pending user data is associated with the at least one rule, wherein, to transmit the enforced RSP rule information, the at least one processor is configured to transmit the enforced RSP rule information with an uplink data status information element (IE) indicative of whether each PDU session of the at least one PDU session is associated with the pending user data to be transmitted based on the determination.

Aspect 4: The first network entity of any of aspects through, wherein to transmit the enforced RSP rule information, the at least one processor is configured to transmit the enforced RSP rule information in a protocol data unit (PDU) session establishment request.

Aspect 5: The first network entity of any of aspects through 3, wherein to transmit the enforced RSP rule information, the at least one processor is configured to transmit the enforced RSP rule information in a protocol data unit (PDU) session modification request.

Aspect 6: The first network entity of any of aspects through, wherein the enforced RSP rule information is associated with a policy and charging control (PCC) rule.

Aspect 7: The first network entity of any of aspects through, wherein the information associated with the enforced RSP rule information comprises a request for the first network entity to transmit the enforced RSP rule information.

Aspect 8: The first network entity of any of aspects through, wherein to transmit the enforced RSP rule information, the at least one processor is configured to transmit the enforced RSP rule information to a policy control function (PCF).

Aspect 9: The first network entity of any of aspects through, wherein to receive the set of RSP rules, the at least one processor is configured to receive the set of RSP rules from a policy control function (PCF).

Aspect 10: The first network entity of any of aspects through, wherein the information associated with enforced RSP rule information includes one or more traffic descriptors associated with respective rules of the set of RSP rules, the one or more traffic descriptors associate the respective rules of the set of RSP rules with corresponding applications whose data traffic routing is enforced.

Aspect 11: A first network entity for wireless communication, comprising: a memory; and at least one processor coupled to the memory, wherein the at least one processor is configured to: transmit, for a second network entity, a set of route selection policy (RSP) rules; transmit, for the second network entity, information associated with enforced RSP rule information, wherein the enforced RSP rule information pertains to enforcement, by the second network entity, of at least one rule of the set of RSP rules; and receive the enforced RSP rule information based on transmitting the information associated with the enforced RSP rule information.

Aspect 12: The first network entity of aspect, wherein the enforced RSP rule information is associated with a service request associated with at least one protocol data unit (PDU) session.

Aspect 13: The first network entity of any of aspects through, wherein the at least one processor is configured to transmit, for a third network entity, the enforced RSP rule information; and receive a policy and charging control (PCC) rule for enabling a type of quality of service (QoS) flow, wherein the PCC rule is based on the enforced RSP rule information.

Aspect 14: The first network entity of any of aspects through, wherein the information associated with the enforced RSP rule information comprises a request for the enforced RSP rule information.

Aspect 15: The first network entity of any of aspects through, wherein the first network entity is a policy control function (PCF).

Aspect 16: The first network entity of any of aspects through, wherein to receive the enforced RSP rule information, the at least one processor is configured to receive the enforced RSP rule information from a session management function (SMF).

Aspect 17: The first network entity of any of aspects through, wherein the information associated with enforced RSP rule information includes one or more traffic descriptors associated with respective rules of the set of RSP rules, the one or more traffic descriptors associate the respective rules of the set of RSP rules with corresponding applications whose data traffic routing is enforced.

Aspect 18: A first network entity for wireless communication, comprising: a memory; and at least one processor coupled to the memory, wherein the at least one processor is configured to: receive, from a second network entity and in a protocol data unit (PDU) session associated with a service request, enforced route selection policy (RSP) rule information, wherein the enforced RSP rule information pertains to enforcement, by a third network entity, of at least one rule of a set of RSP rules; and transmit, to a fourth network entity, the enforced RSP rule information.

Aspect 19: The first network entity of aspect, wherein to receive the enforced RSP rule information, the at least one processor is configured to receive the enforced RSP rule information with an uplink data status information element (IE) indicative of whether the PDU session is associated with pending user data at the third network entity.

Aspect 20: The first network entity of any of aspects through, wherein to receive the enforced RSP rule information, the at least one processor is configured to receive the enforced RSP rule information in a PDU session establishment request.

Aspect 21: The first network entity of any of aspects through 19, wherein to receive the enforced RSP rule information, the at least one processor is configured to receive the enforced RSP rule information in a PDU session modification request.

Aspect 22 is a method of wireless communication for implementing any of aspects 1 to 10.

Aspect 23 is an apparatus for wireless communication including means for implementing any of aspects 1 to 10.

Aspect 24 is a computer-readable medium (e.g., a non-transitory computer-readable medium) storing computer executable code, where the code when executed by a processor causes the processor to implement any of aspects 1 to 10.

Aspect 25 is a method of wireless communication for implementing any of aspects 11 to 16.

Aspect 26 is an apparatus for wireless communication including means for implementing any of aspects 11 to 16.

Aspect 27 is a computer-readable medium (e.g., a non-transitory computer-readable medium) storing computer executable code, where the code when executed by a processor causes the processor to implement any of aspects 11 to 16.

Aspect 28 is a method of wireless communication for implementing any of aspects 17 to 21.

Aspect 29 is an apparatus for wireless communication including means for implementing any of aspects 17 to 21.

Aspect 23 is a computer-readable medium (e.g., a non-transitory computer-readable medium) storing computer executable code, where the code when executed by a processor causes the processor to implement any of aspects 17 to 21.

1. A first network entity for wireless communication, comprising: a memory; and
at least one processor coupled to the memory, wherein the at least one processor is configured to:
receive, from a second network entity, a set of route selection policy (RSP) rules;
receive, from the second network entity, information associated with enforced RSP rule information, wherein the enforced RSP rule information pertains to enforcement, by the first network entity, of at least one rule of the set of RSP rules; and
transmit, to a third network entity, the enforced RSP rule information based on receiving the information associated with the enforced RSP rule information.

2. The first network entity of claim 1, wherein, to transmit the enforced RSP rule information, the at least one processor is configured to transmit the enforced RSP rule information in a service request associated with at least one protocol data unit (PDU) session.

3. The first network entity of claim 2, further comprising: determining, while the first network entity⁷ is in an idle state, whether pending user data is associated with the at least one rule, wherein, to transmit the enforced RSP rule information, the at least one processor is configured to transmit the enforced RSP rule information with an uplink data status information element (IE) indicative of whether each PDU session of the at least one PDU session is associated with the pending user data to be transmitted based on the determination.

4. The first network entity of claim 1, wherein, to transmit the enforced RSP rule information, the at least one processor is configured to transmit the enforced RSP rule information in a protocol data unit (PDU) session establishment request.

5. The first network entity of claim 1. wherein, to transmit the enforced RSP rule information, the at least one processor is configured to transmit the enforced RSP rule information in a protocol data unit (PDU) session modification request.

6. The first network entity of claim 1, wherein the enforced RSP rule information is associated with a policy and charging control (PCC) rule.

7. The first network entity of claim 1. wherein the information associated with the enforced RSP rule information comprises a request for the first network entity to transmit the enforced RSP rule information.

8. The first network entity of claim 1. wherein to transmit the enforced RSP rule information, the at least one processor is configured to transmit the enforced RSP rule information to a policy control function (PCF).

9. The first network entity of claim 1. wherein to receive the set of RSP rules, the at least one processor is configured to receive the set of RSP rules from a policy control function (PCF).

10. The first network entity of claim 1, wherein the information associated with enforced RSP rule information includes one or more traffic descriptors associated with respective rules of the set of RSP rules, wherein the one or more traffic descriptors associate the respective rules of the set of RSP rules with corresponding applications whose data traffic routing is enforced.

11. A first network entity for wireless communication, comprising: a memory; and
at least one processor coupled to the memory, wherein the at least one processor is configured to:
transmit, for a second network entity, a set of route selection policy (RSP) rules;
transmit, for the second network entity, information associated with enforced RSP rule information, wherein the enforced RSP rule information pertains to enforcement, by the second network entity, of at least one rule of the set of RSP rules; and
receive the enforced RSP rule information based on transmitting the information associated with the enforced RSP rule information.

12. The first network entity of claim 11, wherein the enforced RSP rule information is associated with a service request associated with at least one protocol data unit (PDU) session.

13. The first network entity of claim 11, wherein the at least one processor is configured to:
transmit, for a third network entity, the enforced RSP rule information; and
receive a policy and charging control (PCC) rule for enabling a type of quality of service (QoS) flow, wherein the PCC rule is based on the enforced RSP rule information.

14. The first network entity of claim 11, wherein the information associated with the enforced RSP rule information comprises a request for the enforced RSP rule information.

15. The first network entity of claim 11, wherein the first network entity is a policy control function (PCF).

16. The first network entity of claim 11, wherein to receive the enforced RSP rule information, the at least one processor is configured to receive the enforced RSP rule information from a session management function (SMF).

17. The first network entity of claim 11, wherein the information associated with enforced RSP rule information includes one or more traffic descriptors associated with respective rules of the set of RSP rules, wherein the one or more traffic descriptors associate the respective rules of the set of RSP rules with corresponding applications whose data traffic routing is enforced.

18. A first network entity for wireless communication, comprising: a memory; and
at least one processor coupled to the memory, wherein the at least one processor is configured to:
receive, from a second network entity and in a protocol data unit (PDU) session associated with a sendee request, enforced route selection policy (RSP) rule information, wherein the enforced RSP rule information pertains to enforcement, by a third network entity, of at least one rule of a set of RSP rules; and
transmit, to a fourth network entity, the enforced RSP rule information.

19. The first network entity of claim 18, wherein, to receive the enforced RSP rule information, the at least one processor is configured to receive the enforced RSP rule information with an uplink data status information element (IE) indicative of whether the PDU session is associated with pending user data at the third network entity.

20. The first network entity of claim 18, wherein, to receive the enforced RSP rule information, the at least one processor is configured to receive the enforced RSP rule information in a PDU session establishment request.

21-30. (canceled)
